(19) United States
(12) Patent Application Publication
(10) Pub. No.: US 2024/0091978 A1
(43) Pub. Date: Mar. 21, 2024

(54) SEMI-INCOMBUSTIBLE PANEL BOARD AND METHOD FOR PRODUCING SAME

(71) Applicant: Uni-Wood Corporation Co., Ltd., Nishinomiya-shi, Hyogo (JP)

(72) Inventor: Kuniharu YOKOO, Nishinomiya-shi (JP)

(73) Assignee: Uni-Wood Corporation Co., Ltd., Nishinomiya-shi, Hyogo (JP)

(21) Appl. No.: 18/267,360

(22) PCT Filed: Sep. 27, 2021
(86) PCT No.: PCT/JP2021/035316

§ 371 Date: Jun. 14, 2023

(30) Foreign Application Priority Data
Dec. 15, 2020 (JP) 2020-207585

(51) Int. Cl. B27D 1/04; B27D 5/00; B27N 3/04

(52) U.S. Cl. CPC B27D 1/04; B27D 5/00; B27N 3/04

(57) ABSTRACT

To improve the reliability of fire resistance with regard to wood materials containing a fireproofing treatment agent such as a semi-incombustible wood material while also improving both the ease of procuring raw materials and mass productivity, a panel board includes front/back veneers constituting the front and back thereof and a core veneer layer between the front/back veneers. The veneer fiber direction of the front/back veneers is substantially parallel to the lengthwise direction of the panel board. The core veneer layer is a layer obtained by stacking a plurality of sheets of core veneer in the thickness direction. The veneer fiber directions of all of the sheets of the core veneer are substantially orthogonal to the lengthwise direction of panel board. The front/back veneers has a thickness of 1.5-4.0 mm, and the thickness of the core veneer layer 31 is equal to or greater than the total thickness of the front/back veneer 21. Lathe checks and cracks are exposed on the board grain surfaces of all the front/back veneer 21, and an aqueous solution of a fireproofing agent is infiltrated therefrom.

### TECHNICAL FIELD

The present invention relates to a panel board having semi-incombustible performance and a method for producing the same.

### BACKGROUND ART

Current Status of Semi-Incombustible or Flame-Retardant Wood

Most of the chemical-injected woods in circulation today are manufactured by impregnating wood materials with chemicals for subjecting to treatments of preservative, mothproof, flame-retardant, and semi-incombustible. For example, in adopting a method of injecting chemicals into lumber or a lamina for a laminated lumber, it has been carried out to slightly increase the amount of chemicals injected area by subjecting to incising processing, but the degree of penetration of the chemicals is markedly different between the heartwood section and sapwood section. As a result, there was a large fluctuation in the performance of the chemical-injected woods and the performance of the wood products, and it could be seen that some of them did not meet the standard values for chemical-treated wood. When flame-retardant semi-incombustible treated wood materials existing an area to which injection of chemicals is insufficient are heated, combustible gases are generated from the wood tissue at the insufficient area by reaching to a high temperature region of around 200° C. or higher, and these gases ignite, whereby its fire-proof performance is greatly impaired.

Changes in the Market for Lumber in Japan Today

When the market of lumber in Japan today is surviewed, the following changes can be observed.

The market for single-family wooden houses, which is the largest market for lumber, is shrinking due to the decreasing birthrate and aging population.

On the other hand, in medium to large scale buildings where an unspecified number of people gather such as public facilities, stores, offices, lodging facilities, etc., it is required that the spaces that can create a “comfortable” and “fashionable image” as well as maintain a healthy humidity level of 50% to 60% that is resistant to microorganisms such as viruses, etc., and the market for interior and exterior wood products is expanding. In such medium to large scale buildings where an unspecified number of people gather, safety in case of fire is an important factor, so that the demand for lumber that satisfies stable performance of “flame-retardant and semi-incombustible” is increasing.

### Problems of Conventional Products and Technologies and their Effects

Next, when the problems in technology of the conventional products that have been offered until today and their effects are summarized, it can be understood that they are in the following situation.
In the flame-retardant and semi-incombustible woods in the conventional products, there exist a part that the injection amount of the fireproofing treatment agent is insufficient. As a result, there are some products with insufficient in performance, and reliability to the performance of flame-retardant and semi-incombustible woods is impaired.
In order to achieve the minimum value of the injection amount to the standard value, excessive injection of noncombustible chemicals is carried out, and as a result, increase in the cost and the phenomenon of white florescence on the surface of the product is caused.

### Technical Fundamental Knowledge

The technical fundamental knowledge of the present invention are as follows.
Knowledge of the fact that liquid water or aqueous solution hardly moves in wood except for sapwood.
Knowledge of the fact that the movement of liquid water or aqueous solution in wood is mainly in the direction of the fibers and the movement in the direction orthogonal to the fibers is very slow.
In the case of laminated veneer lumber, the aqueous solution does not move across the fibers in the direction orthogonal to the fibers, but rather cracks of the veneer backs or finer cracks are generated along the slightly inclined fibers from the longitudinal direction by the rotary lathe manufacturing process, and the aqueous solution infiltrates through them. As a result, it was found that the aqueous solution appears to have moved in the lateral direction as well.
There are three kinds of chemical injection treatments depending on the object of the chemical treatment, these three kinds of the mothproof treatment (chemical injection into the sapwood section where high nutrients for insects such as starch contain), the preservative treatment (chemical treatment only on the periphery section of the wood) and the semi-incombustible and flame-retardant chemical treatment (uniform chemical injection treatments for the wood) should be clearly distinguished, and the treatment suitable for the semi-incombustible and flame-retardant chemical treatment (uniform chemical injection treatments for the wood) should be carried out.
In the injection chemicals for the treatment of flame-retardant and semi-incombustible, there are adhesion inhibiting factors in many cases, and when the lumbers are adhered after injection, sufficient adhesive strength for the application may not be obtained in many cases.

### Prior Art Documents and Problems Thereof

As the prior art documents for such fire-proof modified wood materials, there may be mentioned Patent Documents 1 to 5, but no proposal has been made to accurately understand the mobility of liquid in the fiber direction and to utilize this mobility.

Specifically, in the paragraph 0014 of the specification of Patent Document 1, a time for applying an immersion treatment is set for a range with a large width as 6 to 72 hours, and as the reasons therefor, there may be mentioned that the thickness and arrangement of the conduits vary depending on the kind of woods, and an example thereof, it is pointed out that the sapwood section has thicker conduits and coarse density. However, in the Examples below paragraph 0022 of the specification, only a cedar board or a paulownia board is used as the raw material wood, in the cedar as if the conduit exists, the conduit itself does not exist, and regarding the paulownia, there is a doubt in the recognition itself that it is a diffuse-porous broad-leaved tree and an aqueous solution can be injected around the conduit of the sapwood section, and when the sapwood section is the cedar and paulownia, the conduit is thick and the density is low. Thus, Patent Document 1 does not disclose a veneer lamination structure of a panel board considering the movement of water-soluble chemicals in the fiber direction and suitable for the above.

Even in Patent Document 2, in the paragraph 0011 of the specification, it is shown that a sufficient fireproofing agent is impregnated at the conduit and its surrounding area, but in Examples below in the paragraph 0017 of the specification, as a raw material wood, only a paulownia board is used, and the heartwood section and the sapwood section are not used separately. Thus, in Patent Document 2, in other words, without distinguishing between the heartwood section and the sapwood section, it can be admitted that it is disclosed the technical concept that, noncombustible properties can be markedly improved by the formation of a glass-like film which is presumed to be formed by the cross-linking reaction to the fire-proof chemical liquid impregnated in the paulownia wood and tannin latently impregnated in the paulownia wood by heat. In addition, the inventor of the present invention has never heard the story that the paulownia wood has specific tannin that is unique to the paulownia wood, and even when it undergoes a cross-linking reaction, it is still an organic substance, thus it is considered that the difficulty of burning is irrelevant.

Thus, even in Patent Document 2, it does not disclose a veneer lamination structure of a panel board considering the movement of water-soluble chemicals in the fiber direction.

In Patent Document 3, it proposes a method of injecting a chemical liquid into a veneer which comprises of adhering a chemical liquid only to the portion of a plurality of projections for forming recesses, compressing the veneer to the thickness or less by pressing the projections against the dried veneer and after contacting the chemical liquid with the veneer, releasing the projections from the veneer to permeate the chemical liquid into the tissue of the veneer. However, in the method of this Patent Document 3, it is difficult to consider that the chemical enters the interior of the wood, and even when the chemical is adhered only to the portion of the projections for forming recesses, there is almost no movement of the chemical in the heartwood section.

Thus, even in Patent Document 3, it does not disclose a veneer lamination structure of a panel board considering the movement of water-soluble chemicals in the fiber direction.

In Patent Document 4, it is proposed that hollow portions and grooves which are continuous or intermittent in the length direction of a rectangular lumber are formed on a laminated portion of a lumber except for a front side portion and a rear side portion of the rectangular lumber, a filler is injected into a part of these hollow portions or grooves to form a number of wall constituent materials, and after connecting these wall constituent materials by stacking vertically with a connecting means, a filler is injected into the unfilled portions of the hollow portions or grooves to close the connection gaps of the respective wall constituent materials thereby constructing an integrated wall. In Patent Document 4, however, although the chemical liquid can be injected into the hollow portions or grooves formed between the lumbers, the chemical liquid cannot be injected into the interior of each lumber, and movement of the chemical liquid inside each lumber cannot be expected.

Thus, even Patent Document 4 does not disclose a veneer lamination structure of a panel board considering the movement of water-soluble chemicals in the fiber direction.

In Patent Document 5, a chemical liquid is dripped into a groove in which each of the four sides of the wood is subjected to back split processing by a saw to pour into the inside of the wood. In addition, holes are drilled at the right angles to the back split from each of the four surfaces of the wood, and the resin that has flowed inside the wood enters the horizontal holes and forms a rib. Wood and wood processed product whose surface has treated with a chemical liquid at the time when the synthetic resin solution has cured are proposed. However, even in this Patent Document 5, the heartwood section and the sapwood section are not used by distinguishing to each other, and in the heartwood section, movement of the chemical liquid is difficult. Moreover, the grooves subjected to back split processing by sawing are provided along the direction of extending the fiber of wood, so that it can hardly expect of movement of the chemical liquid between the grooves. Thus, even in Patent Document 5, it does not disclose a veneer lamination structure of a panel board considering the movement of water-soluble chemicals in the fiber direction.

Utilization of Japanese Cedar (Sugi) Resources in Japan Today

On the other hand, turning to the Japanese cedar which is a representative resource of conifers in Japan, there are a large number of resources of Japanese cedar in Japan. At present, the main products of Japanese cedar in Japan are pillars and beams obtained by sawing the central part of Japanese cedar logs into a form called “boxed heart” or “free of heart center”. On the other hand, as for the portion of the sapwood, a roof board has conventionally been employed, but the demand for these boards is now being met by plywood, so there is no use for these boards at present.

As mentioned above, the heartwood section of conifers including Japanese cedar is a biological material so that it has a cell structure that prevents penetration of foreign substances from the outside. The sapwood section, which is the part of vital activity of the tree, has a structure suitable for transferring water from the ground to the leaves, and in the wood of the sapwood section, an aqueous chemical solution easily moves in the fiber direction.

Specifically, in Japanese cedar, except for the sapwood section, the aqueous chemical solution infiltrates only about 50 mm or so in the fiber direction and infiltrates only about 5 mm or so in the orthogonal direction to the fiber direction by the usual decompression/pressurization injection.

On the other in the sapwood section of the Japanese cedar, it has confirmed by the preliminary tests carried out by the present inventor that the aqueous chemical solution infiltrates 100 mm or more in the fiber direction and infiltrates 5 mm or more in the orthogonal direction to the fiber direction by the usual decompression/pressurization injection.

### PRIOR INVENTION AND PATENT APPLICATION

Based on this knowledge, the present inventor completed the invention of semi-incombustible or flame-retardant wood and filed a patent application under Japanese Patent Application No. 2018-226298 on Dec. 3, 2018, and this present application was published as Patent Document 6.

An object of the invention according to this Patent Document 6 is to provide a semi-incombustible or flame-retardant wood capable of exhibiting uniform fire-proof performance and a method for manufacturing the same, and is to provide a semi-incombustible or flame-retardant wood using only conifers such as Japanese cedar, or sapwood of diffuse-porous broadleaved tree material as a raw material. At that time, injection holes are formed in the wood at appropriate intervals and at a predetermined depth, and the woods are laminated with an adhesive with the overlapping surfaces facing inside. It was to provide a semi-incombustible or flame-retardant wood having almost uniform and stable non-combustibility throughout the entire wood by injecting a fireproofing agent such as a water-soluble, under reduced pressure and pressure into the laminated material processed in this way.

The semi-incombustible or flame-retardant wood of the invention according to this Patent Document 6 is a laminated lumber of Japanese cedar cross-grain sapwood having a thickness of 20 mm, and the surface is constituted by a plain cross-grain material, so that the appearance is very good and the injection holes having a width of 3 mm and a depth of 5 mm on both sides of the laminated surface do not pose any problem in terms of appearance. And when semi-incombustible combustion tests were carried out on the materials in which an amount necessary for semi-incombustible was injected about an incombustible chemical injection amount at a concentration of 25% and 140 to 150 kg/m³, then the results were each acceptable in terms of calorific value and the presence or absence of cracks to the back surface.

However, in this invention, only sapwood was used so that there has been a problem that an amount of raw wood that could be collected from a single tree was limited.

In addition, when perforation is performed as a means for uniformly injecting an effective amount of chemicals into LVL, the influence of a decrease in bending Young's modulus due to cross-sectional defects cannot be avoided, and in particular, when it is carried out as a structural material, this influence cannot be unavoidable, and none of prior art documents disclose or suggest regarding this point.

Delivery Time

In addition, in the conventional semi-incombustible wood interior materials, due to the difference in the portion (sapwood and heartwood) of the wood, the amount of chemical injection has a large variation and it is impossible to produce ready-made products, so that it requires the following steps of inquiry—completion of negotiations—material arrangement—selection of materials—chemical injection—selection of injected products—product drying—finishing process, thus, it used to be required a half year to one year from completion of negotiations to delivery. In addition, depending on the materials, a necessary amount of chemical injection is difficult and some materials had to be discarded, so that there were problems that yield was poor and the cost became high. Thus, these extremely long delivery time and abnormally high costs have been obstacles to the spread of semi-incombustible wood.

### PRIOR ART DOCUMENTS

### Patent Documents

Patent Document 1: Japan Patent No. 4221599
Patent Document 2: Japanese Patent Application Laid-Open Publication No. 2007-63749A
Patent Document 3: Japan Patent No. 3,344,703
Patent Document 4: Japanese Patent Application Laid-Open Publication No. H11-131635A
Patent Document 5: Japanese Patent Application Laid-Open Publication No. H8-281203A
Patent Document 6: Japanese Patent Application Laid-Open Publication No. 2020-89978A

### SUMMARY OF THE INVENTION

### Problems to be Solved by the Invention

An object of the present invention is to improve reliability of fire-proof performance regarding the panel board containing fireproofing chemical and to improve the ease of procurement of raw materials and mass productivity.

### Means to Solve the Problems

The present invention was completed based on the following findings.

First, in the sapwood section of the wood, an aqueous solution moves through the membrane pores of the cell wall in conifers, while in broadleaved tree, an aqueous solution moves in the vessel where no filler is present. On the other hand, in the heartwood section of the wood, since the membrane pores are closed in the conifers, the intracellular filler substance is present in the broadleaved tree, so that movement of the aqueous solution through the cell lumen is impossible. However, in the veneer laminated material using rotary veneers produced by rotary lathe as a raw material, there is no distinction between tree species and sapwood/heartwood, and in either case, it was found that the aqueous solution under decompression/pressurization can be infiltrated in the fiber direction from 100 mm to 250 mm through the lathe checks and cracks of the veneer.

Further, in the infiltration of the aqueous solution in the direction orthogonal to the fiber direction, it was found that the aqueous solution does not move across the fiber direction but moves through the lathe checks of the veneer generated along the fiber slightly inclined from the lengthwise direction, and as a result, the aqueous solution seems to move in the lateral direction as well.

Specifically, the present invention solves the above-mentioned problem by providing a semi-incombustible panel board having the following means.

The panel board of the present invention is provided with front and back veneer constituting the front and back thereof, and a core veneer layer laminated between the above-mentioned front and back veneer.

In the above-mentioned front and back veneer, its veneer fiber direction is substantially parallel to the lengthwise direction of the above-mentioned panel board.

On the other hand, the above-mentioned core veneer layer is a layer in which a plurality of core veneers is overlapped in the thickness direction, and in all of these core veneers, its veneer fiber direction is substantially orthogonal to the lengthwise direction of the above-mentioned panel board.

The above-mentioned front and back veneer has a thickness of 1.5 mm to 4.0 mm, and the thickness of the above-mentioned core veneer layer is equal to or greater than the total thickness of the above-mentioned front and back veneer.

Further in all the above-mentioned front and back veneers, there exists a fireproofing agent infiltrated from the veneer cross-grain surface with an aqueous solution through the lathe checks and cracks. On the other hand, in all the core veneers, there exists a fireproofing treatment agent infiltrated with an aqueous solution through the lathe checks and cracks generated along the veneer fiber direction.

In the present invention, it is obtained by preparing a panel board raw material having the above-mentioned predetermined dimensions in which veneers are laminated by a water-soluble adhesive, and then, a fireproofing treatment agent is injected into the panel board raw material.

A fireproofing agent such as a water-soluble is injected under decompression and pressurization into the panel board raw material obtained by laminating the veneers as mentioned above.

By this, the chemical agent infiltrates from the front and back surface into the above-mentioned front and back veneer, from the veneer cross-grain surface which is the front and back surface of the above-mentioned panel board raw material to the front and back first layer adhesive layer (depth of 4 mm or less).

Also, in the above-mentioned front and back veneer, there are a large number of fine cracks due to the impact applied at the time of the rotary lathe process.

Therefore, when laminating, the cross-grain surface (the surface having cracks on the back of the veneer) of the back side of the above-mentioned front and back veneer may be on the outside and be laminated, or the cross-grain surface (the surface having no cracks on the back of the veneer) of the back side of the above-mentioned front and back veneer may be on the outside and be laminated. Regardless of which cross-grain surface is on the outside, by limiting the plate thickness of the above-mentioned front and back veneer to 1.5 mm to 4.0 mm, it is possible to infiltrate the fireproofing agent from the above-mentioned lathe checks or cracks over the entire thickness.

Also, in all the above-mentioned core veneers constituting the above-mentioned core veneer layers, the veneer fiber direction is substantially orthogonal to the lengthwise direction of the above-mentioned panel board. Therefore, in all the above-mentioned core veneers, all the wood ends are exposed on the left and right side surfaces (edge surfaces) of the semi-incombustible panel board, and the chemical agent infiltrates from the side surfaces of the exposed left and right side surfaces (edge surfaces) and the infiltrated chemical is, by moving in a fluid of the above-mentioned fireproofing treatment agent satisfactorily along the lathe checks of the veneer generated along the above-mentioned fiber, whereby the chemical agent is injected to the whole.

Therefore, the semi-incombustible wood according to the present invention is provided with the above-mentioned core veneer layer in which the fireproofing treatment agent moved in a fluid through the lathe checks of the veneer etc., generated along the above-mentioned vessel and tracheid exists, and the front and back veneer which is located above and below sandwiching the above-mentioned core veneer layer in which the fireproofing treatment agent that has infiltrated from the cross-grain surface, etc., of both the top and bottom surfaces being present.

Since the injection of the aqueous solution of the fireproofing agent moves mainly through the lathe checks of the veneer generated along the inclined fiber direction, the apparent movement in the orthogonal direction to the fiber is limited to a distance of 1/10 to 1/20 of that in the fiber direction. However, it can move a relatively long distance in the fiber direction, and in the preliminary experiment carried out by the present inventor, the following infiltration state is confirmed.

For example, in Japanese cedar sapwood LVL, a chemical agent infiltrates with a length of 150 mm or more in the fiber direction. In LVL in which a veneer comprising a sapwood of cedar and a veneer comprising a heartwood of Japanese cedar are mixed, a chemical agent infiltrates with a length of 150 mm to 200 mm in the fiber direction. In LVL in which a veneer comprising a sapwood of poplar and a veneer comprising a heartwood of poplar are mixed, a chemical agent infiltrates with a length of 150 mm to 200 mm in the fiber direction. Therefore, in the case of the above-mentioned core veneer layer, the chemical agent infiltrates through the wood ends of the left and right sides of each core veneer exposed on the left and right side surfaces of the semi-incombustible panel board, so that regardless of the difference of tree species such a Japanese cedar and poplar or distinction between sapwood and heartwood, when a rotary veneer is used, if the width dimension in the crosswise direction is set to 100 mm to 310 mm, the chemical agent can be evenly infiltrated from the left and right side surfaces to the center of the width direction.

In the case of the front and back veneer constituting the front and back of the panel board, since the veneer fiber direction is substantially parallel to the lengthwise direction of the above-mentioned panel board, the length of the fiber direction of the front and back veneer becomes longer than the length in which the above-mentioned chemical agent infiltrates. However, as mentioned above, there exist lathe checks of the veneer and cracks generated along the inclined fibers in each of the front and back of the above-mentioned front and back veneer. Therefore, the chemical agent infiltrates from these at a depth of about 5 mm or so.

As for the method for producing the semi-incombustible panel board, for example, the following production method can be employed. First, a laminated material is produced by laminating the front and back veneer and the core veneer layer at a width convenient for the production factory, and the produced laminated material is cut to a specified width for the panel board before chemical injection. Chemical agent is injected into the panel board raw material with a predetermined size that has been cut by the width. Other production processes are substantially the same as the conventional method, and unlike the case of a raw material derived from a lumber, since special processes such as lamination and adhesion including boring and slit cutting can be omitted, it is suitable for mass production and costs can be reduced significantly.

In particular, since experimental results have shown that semi-incombustible performance is possible even for wood having a thickness of 12 mm or more, price competitiveness is improved when a product of a veneer laminated material having a thickness of 12 mm to 15 mm is produced with a veneer laminated material rather than a product in which a four-sided processed product having a thickness of 12 mm to 30 mm (twice) is produced with a lumber product since the decrease in yield by planar processing can be suppressed. Further, a semi-incombustible decorative panel board can be also produced at a lower cost if the steps are made that a decorative veneer is pasted to the surface in the state of a broader width board and is cut into a small width board which is a size of the panel board and then subjecting to chemical injection.

Also, the present invention provides, in a method for producing a semi-incombustible panel board, a method for producing a semi-incombustible panel board that can dramatically shorten its delivery time by carrying out the following method.

First, a semi-incombustible panel board for stock is produced. The semi-incombustible panel board for stock is obtained by injecting a fireproofing treatment agent into the panel board raw material for stock which has the same laminated structure and the thickness as those of the above-mentioned semi-incombustible panel board which becomes the object to be delivered, and then is dried and cured. However, this semi-incombustible panel board for stock is larger than the above-mentioned semi-incombustible panel board in at least one of the width dimension and the length dimension.

Then, the semi-incombustible panel board to be delivered is produced by cutting at least any one of the width dimension and the length dimension of the above-mentioned semi-incombustible panel board for stock, which has been stocked in advance.

The above-mentioned semi-incombustible panel board for stock suitably has a thickness of within 30 mm and a width of within 310 mm, and a thickness of the above-mentioned front and back veneer constituting the front and back of the above-mentioned semi-incombustible panel board for stock is suitable for 1.5 mm to 4.0 mm.

In the semi-incombustible panel board according to the present invention, the chemical agent can be uniformly injected in any direction of its thickness, length and width. Therefore, it is possible that the semi-incombustible panel board for stock in which a chemical agent has been injected into a panel board raw material for stock having a predetermined size (for example, a size of thickness: 12 to 30 mm, width: 310 mm and length: 4,100 mm) and dried, can be produced in advance and the inventory is stored, and at the time when an order is received from the customer, the semi-incombustible panel board for stock is cut into the ordered size and delivered. As a result, the delivery time of a semi-incombustible panel board, which used to require six months to a year from completion of negotiations to delivery, can be reduced to the number of days required for cutting and packaging, thus, a novel business model that is enables delivery in about 10 days after receiving an order can be realized.

### Effects of the Invention

The present invention can provide a semi-incombustible panel board that can improve reliability of fireproof performance regarding the panel board containing a fireproofing treatment agent such as semi-incombustible wood and achieve both the ease of procurement of raw materials and improvement of mass productivity, and a method for producing the same.

### BRIEF DESCRIPTION OF THE DRAWINGS

FIG. 1 is a perspective view of the semi-incombustible panel board according to the embodiment of the present invention.

FIG. 2 is a plan view of each layer of the same semi-incombustible panel board.

FIG. 3(A) is an explanatory drawing of the cross-sectional structure of the raw wood for obtaining wood for semi-incombustible wood according to the embodiment of the present invention, and FIG. 3(B) is an explanatory drawing of the cross-sectional structure of the raw wood for obtaining wood for semi-incombustible wood according to the other embodiment.

### EMBODIMENT TO CARRY OUT THE INVENTION

Hereinafter, the embodiments of the present invention will be explained by referring to the drawings.

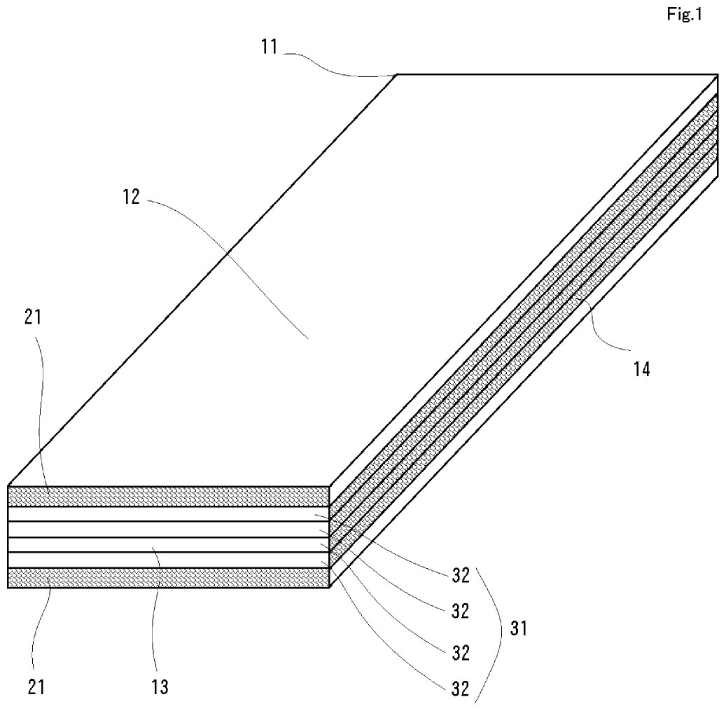

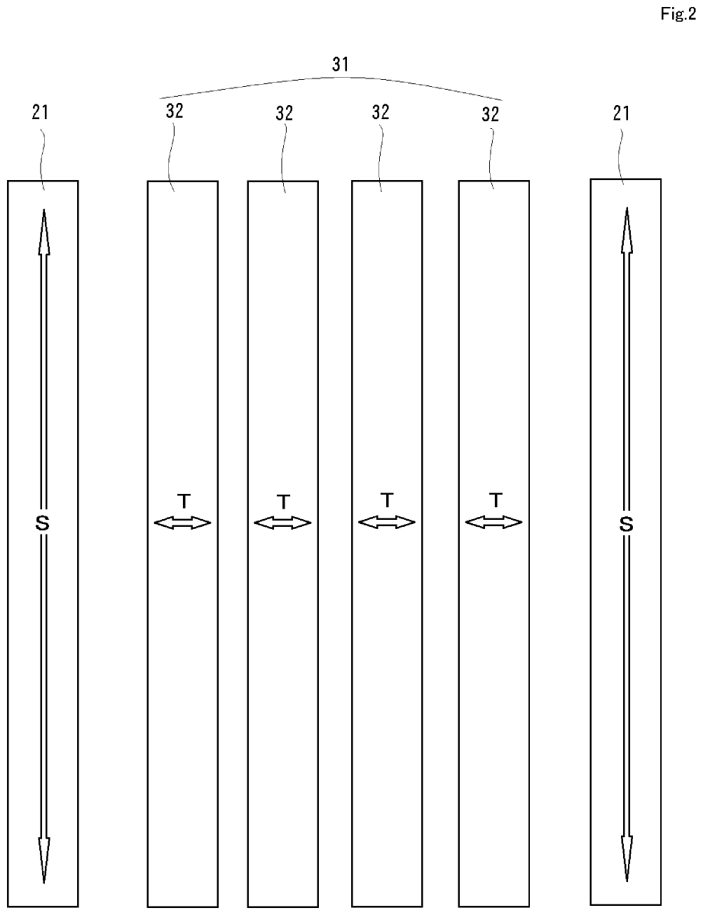

The semi-incombustible panel board 11 according to this embodiment is provided with front and back surface 12, front and rear end surface 13 and left and right side 14 as shown in FIG. 1 and FIG. 2.

The front and back surface 12 of the panel board 11 are constituted by front and back veneer 21.

A core veneer layer 31 is arranged between the front and back veneers 21 at the front and back, and a plurality of core veneers 32 are laminated.

These front and back veneers 21 and core veneers 32 are adhered to each other by an adhesive such as water-resistant adhesive or the like according to the conventional method.

Regarding Front and Back Veneer 21

In the front and back veneer 21, the veneer fiber directions (arrow S shown in FIG. 2) is substantially parallel to the lengthwise direction of the panel board 11, and similar to the panel board of ordinary LVL, the wood end surfaces (end surfaces substantially orthogonal to the fiber direction of the wood) are located on the front and rear end surfaces 13 of the panel board 11. The thickness of the front and back veneer 21 is set to 1.5 mm to 4.0 mm.

Fireproofing Agent of Front and Back Veneer 21

In the front and back veneer 21, an aqueous solution of a fireproofing agent in which the fireproofing treatment agent has infiltrated through the lathe checks and cracks of the cross-grain surface exposed on the front and back surface is present.

Specifically, an aqueous solution of an incombustible, semi-incombustible or flame-retardant treatment chemical, or the like is injected into the panel board 11 finished to a predetermined size using a decompression and pressurization injection can.

At that time, the front and back veneer 21 is exposed on one surface of the front and back surface 12 of the panel board 11, as well as four surfaces of the front and rear end surface 13 and the left and right side 14. Therefore, although the aqueous solution of the chemical agent is injected from these surfaces, the movement distance of the aqueous solution of the chemical agent from the four surfaces of the front and rear end surface (that is, the wood end surface) 13 and the left and right side (that is, edge surfaces) 14 is shorter than the total length of the panel board 11. However, since one surface of the front and back surfaces (that is, cross-grain surfaces) 12 of the panel board 11 is exposed on the entire surface, the aqueous solution of the chemical agent from the front and back surfaces 12 infiltrates into inside through the lathe checks and cracks of the wood from the entire surface.

Regarding Core Veneer Layer 31

In all the core veneers 32 constituting the core veneer layer 31, the veneer fiber direction (arrow T shown in FIG. 2) is substantially orthogonal to the lengthwise direction of the panel board 11.

Unlike the panel board of normal LVL, its wood end surface (end surface substantially orthogonal to the fiber direction of the wood) is exposed on the left and right sides 14 of the panel board 11. A thickness of the core veneer layer 31 is the total thickness or more of the front and back veneers 21 of 2 sheets of the front and back.

Fireproofing Agent of Core Veneer Layer 31

In all the core veneers 32, the fireproofing treatment agent which is moved in a fluid through the lathe checks of the veneer generated along the tracheid or vessel is present throughout thereof.

Specifically, an aqueous solution such as an incombustible, semi-incombustible or flame-retardant treatment chemical agent is injected into the panel board 11 finished to a predetermined size using a decompression/pressurization injection can.

At that time, the core veneer 32 is exposed on the four surfaces of the front and rear end surface 13 and the left and right side 14. Therefore, although the aqueous solution of the chemical agent is injected from these surfaces, the veneer fiber direction (arrow T) is arranged in the width direction of the panel board 11, so that the movement distance of the aqueous solution of the chemical agent from the two surfaces of the front and rear end surface 13 is shorter than the movement distance of the two surfaces of the left and right side 14. However, the aqueous solution such as the incombustible, semi-incombustible or flame-retardant treatment chemical injected from the two surfaces of the left and right side 14 can move a certain distance along the veneer fiber direction (arrow T). Specifically, it has been confirmed by the present inventor's preliminary test that, when the core veneer 32 is a veneer comprising Japanese cedar sapwood and core wood, the chemical agent infiltrates in the veneer fiber direction (arrow T) with a length of 150 mm or more, when a veneer is a veneer comprising sapwood of Japanese cedar and a veneer comprising wood core, the chemical agent infiltrates in the veneer fiber direction (arrow T) with a length of 150 mm to 200 mm, and when a veneer is a veneer comprising sapwood of poplar and a veneer comprising wood core, the chemical agent infiltrates in the veneer fiber direction (arrow T) with a length of 80 mm to 200 mm.

Thus, by limiting the width of the panel board 11 to within twice the movable distance of the aqueous solution of the chemical agent in the veneer fiber direction (arrow T) in the core veneer 32, the aqueous solution of the chemical agent injected from the left and right wood end surfaces of the core veneer 32 which are exposed on the left and right side 14 of the left and right of the panel board 11 can reach the entire width.

Therefore, the aqueous solution of the chemical agent can be reliably and uniformly present over the entire core veneer 32.

Production of Wood 11

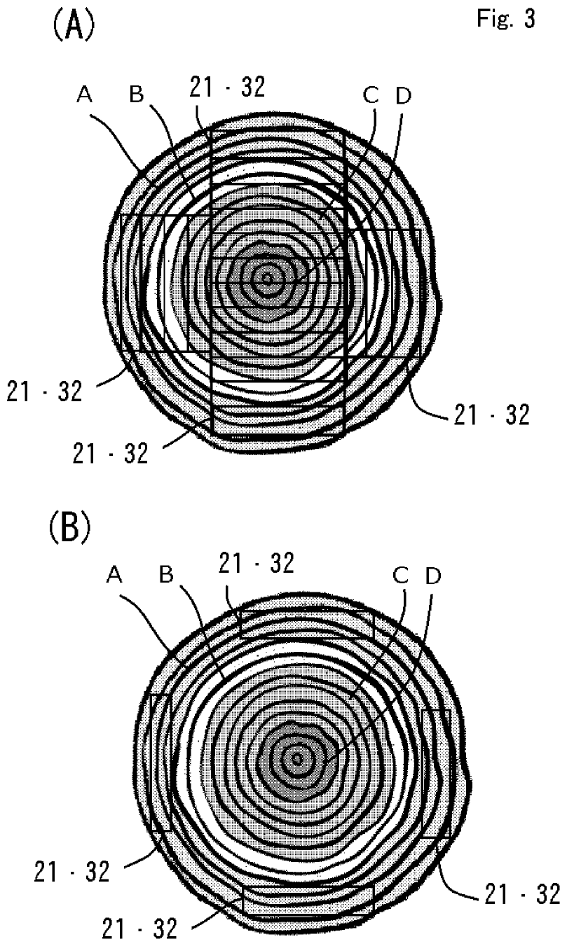

In general, wood is often roughly classified into a sapwood section and a heartwood section, the sapwood section refers to the whitish part of the outer peripheral part of the cross section of a log, while the heartwood section is said to be referred to the reddish part of the center of the cross section of a log, and more specifically, the heartwood section can be classified into two regions of the immature part and the mature part in the center portion, and there may be a case where a white line zone may exist at the boundary region between the sapwood section and the heartwood section. Therefore, as shown in FIG. 3, it can be divided into four regions from the outside, a sapwood section A, a white line zone B, a heartwood matured section C and a heartwood unmatured section D, and in the present invention, when simply referred to as the heartwood section, it indicates a section including the white line zone B, the heartwood matured section C, and the heartwood unmatured section D.

In the present invention, as shown in FIG. 3(A), not only the sapwood section A which has good fluid movement, but also the heartwood section which has relatively poor fluid movement, the chemical agent infiltrates 80 mm to 200 mm or more as mentioned above.

Therefore, depending on the required width of the veneers 21 and 32 of the panel board 11, by selecting and using the most appropriate tree species and the most appropriate sections, it is possible to produce the panel board 11 in which the incombustible, semi-incombustible or flame-retardant treatment chemical is well present throughout the entire panel board 11.

Of course, as shown in FIG. 3(B), it may be also possible to use only the sapwood section A in which the liquid moves well inside the wood in the direction of fiber elongation, or may be used without distinguishing these.

For example, when a veneer comprising Japanese cedar sapwood is used as the core veneer 32, and when the veneer comprising the sapwood of Japanese cedar and a veneer comprising a core material are used in admixture without distinction, or when a veneer comprising the sapwood of poplar and a veneer comprising wood core are used in admixture without distinction, or the like, regardless of the tree species or distinction between sapwood and heartwood, if it is a rotary veneer, it is suitable that a thickness of the entire panel board 11 is 12 mm to 30 mm, a width thereof is 100 mm to 310 mm, and a length thereof is 2,000 mm to 4,500 mm.

Injection of Chemical Agent

The injection processing of the chemical agent is, as mentioned above, a step of preparing a panel board raw material having a predetermined dimension in which the veneers are laminated by a water-soluble adhesive or the like and injecting the incombustible treatment chemical into the panel board raw material. Specifically, a semi-incombustible wood is completed by injecting an aqueous solution such as an incombustible, semi-incombustible or flame-retardant treatment to the panel board raw material using a decompression and pressurization injection can.

An injection amount of the chemical agent may be set according to the dimensions of the front and back veneers 21 and the core veneer layer 31, the species of tree, and the regional differences in which they have grown, and as a rough estimate in the case of Japanese cedar produced in Japan, it is suitable to set about 150 kg/m³ for a wood 11 having a thickness of 18 mm.

Incidentally, since the impregnation state of the chemical liquid changes depending on the kind and growth conditions of the wood, it is preferable to carry out preliminary experiments by confirming the depressurization conditions and time, the pressurization conditions and time, and the number of repetitions using a water-soluble colorant.

In addition, as for the injection amount for process control, it is preferable that the weight before and after the injection be measured and the difference be controlled as an average injection amount of the lot.

Process after injection Curing: It is preferable to carry out curing including drying for equalization of inside the wood of the injected chemical agent, and the period of curing is determined by preliminary experiments.

Drying: Moisture content is controlled in order to satisfy the quality of the merchandise as determined by agreement with the customer. From the viewpoint of improving quality, it is preferable to carry out artificial drying.

Finishing process: In order to meet the predetermined conditions as the merchandise, finishing process is applied rip-sawing to the width, cross-cut-sawing to the length, and sanding or molding to the surface.

Inspection: In order to satisfy the quality as the merchandise, necessary inspection is carried out. For example, the thickness and width are measured with a caliper, and the length is measured with a steel tape measure, and the appearance and surface are confirmed visually and by touch.

Packing: Necessary packing is applied so that the products of semi-incombustible wood are bundled in a small bundle and covered on six sides to protect them from outside moisture, or covered with a plastic sheet and fixed with tape so as not to damage to the cargo.

The semi-incombustible wood according to this embodiment can exhibit almost uniform and good fire-proof performance as a whole fire-proof modified wood material. When wood materials having the portion at which chemical injection is insufficient are heated, combustible gas is generated from the wood tissue of the insufficient portion by reaching a high temperature region of around 200° C. or higher, and the gas ignites. As a result, the fire-proof performance is markedly impaired, but the panel board 11 of the present invention is impregnated with a sufficient amount of the chemical for fire-proof substantially entirely, so that generation of combustible gas from the wood tissue can be suppressed and stable fire-proof performance can be shown.

Process Control

In the implementation of the present invention, process control is important to ensure that all the panel board 11 produced show stable fire-proof performance.

Verification of Infiltration Length

After pre-drying, 4 to 6 samples are collected for each production lot, and a stain injection test is carried out to confirm the infiltration length of the chemical agent. In the test method, after injecting the stain solution under depressurization and pressurization, the samples are cut every 10 cm in length to confirm infiltration property of the stain solution on the cut surface.

Measurement of Moisture Content Before Injection

Since the moisture content before injection affects the impregnation of the chemical, it is important to measure the moisture content with a high-frequency moisture content meter. Desirably, six test pieces are randomly collected for each production lot and measured also by the all-dry method.

Measurement of Chemical Injection Amount

The weight of the injection lot before and after the decompression and pressurization process for each injection lot is measured, and management of the difference is carried out as an average chemical injection amount of the lot, whereby it is confirmed that whether a sufficient amount of the chemical is injected or not.

Measurement of Moisture Content after Drying

Six samples are taken for each production lot, the weight is measured by the all-dry method, and the average amount of the chemical is subtracted from the measured weight to estimate the moisture content. A correlation table between these values and the numerical values of the high-frequency moisture content meter is prepared to carry out the measurement of the moisture content of small lots of products.

Confirmation of Dimensional Accuracy

The thickness and width of the panel board 11 are measured with calipers. Accuracy depends on the agreement with the customer.

The length of the panel board 11 is measured with a steel tape measure. Accuracy depends on the agreement with the customer.

Product Inspection

The appearance inspection of all the products is carried out visually. The content depends on the agreement with the customer.

Confirmation of Packaging

The products are covered on all six sides with a plastic sheet after bundling to protect it from being exposed to the outside air.

The product is wrapped with a pallet or kraft paper necessary to prevent damage caused by handling cargo.

Confirmation of Display

A paper written the following information is attached to the side, and the front and rear end surfaces of the outside of package.

Product name, product grade, raw material tree species, kind of chemical agent for treatment, product dimensions, product quantity (number contained), producer name, production place, production lot number and bundle number.

Quality Control

In addition to process control as mentioned above, quality control is thoroughly implemented, and only products that show stable fire-proof performance are shipped.
Combustion Test is Carried Out in Accordance with the Ordinance of the Ministry of Land, Infrastructure, Transport and Tourism. Specifically, the number of samples according to the required population is measured by a cone calorimeter under predetermined conditions. Accuracy of process control can be improved by preparing a relative relationship record between the cone calorimeter test result and the injection amount for each injection lot.
Management of chemical agent injection amount which is management of the amount of the chemical agent before and after chemical injection (frequency=each production lot) is carried out. Specifically, the weight of the material placed on the cart before and after the injection is measured, the difference is calculated and divided by the volume of wood to obtain the average amount of injected chemical agent per m³ of the lot.

The core veneer 32 according to this embodiment can be implemented as a single piece of lumber, or can be implemented as a plurality of pieces of wood arranged in the longitudinal direction of the panel board 11.

The biggest problem of semi-incombustible wood products is a problem of stability of the quality such that since a fireproofing agent is not evenly injected into the wood, the quality varies and some products are not subjected to chemical agent injection with an effective amount, or efflorescence is occurred due to too much chemical agent being injected. It is sometimes heard a story from people involved in the construction industry that the supplier gives irresponsible answer such as “wood is a material for living things, so the quality is originally different, so it can't be helped.” and they are willing to deliver poor quality materials without hesitation.

On the other hand, in the current situation where interest in wooden buildings is rapidly deepening due to the government's policy to reduce the amount of CO₂ emissions in Japan to 0 by 2050, by implementing the present invention, a semi-incombustible panel board with stable quality can be mass-produced and supplied at low cost.

### EXAMPLES

Hereinafter, Examples will be shown in order to enhance the understanding of the invention, but the present invention should not be understood as being limited to this Examples.

Preparation of Samples 1 and 2 According to Example

Using poplar as raw wood, a veneer material having a thickness of 1.7 mm was produced using a rotary lathe in accordance with the description (Production of wood 11) as mentioned above, and necessary processing such as cutting and laminating was applied to this veneer material to produce panel boards 11 according to Sample 1 and Sample 2, in which veneers 21 and 32 provided with predetermined veneer fiber directions S and T are laminated. At that time, the sapwood section A, the white line zone B, the heartwood matured section C and the heartwood unmatured section D were used without distinction.
Dimensions of the panel board 11 according to Sample 1: 12 mm×110 mm×1,200 mm
Dimensions of the panel board 11 according to Sample 2: 12 mm×300 mm×1,200 mm

Although the injection amount varies depending on the tree species, thickness of the veneer, or the like and can be practically changed by adjusting the concentration of chemical agent, in this Example, in accordance with the description (Injection of chemical) as mentioned above, the chemical agent was injected into the panel boards 11 according to Sample 1 and Sample 2 using a decompression and pressurization injection can under the following conditions, and then drying and curing were performed to complete Sample 1 and Sample 2.

Chemical Agent Injection Conditions

Injection chemical agent: Phosphorus-nitrogen-based compound type flame-retardant chemical W2-50 manufactured by Marubishi Oil Chemical Co., Ltd., concentration of 20% Decompression: 0.1 atm, 1 hour Pressurization: 8.0 atm, 1 hour

Confirmation of Injection Amount

The amount of chemical agent injected into each of the obtained 30 sheets of the panel boards of Sample 1 and Sample 2 was confirmed with their respective variation (average, standard deviation (σ) and mean −3σ) by weight measurement and statistical processing, and the results are shown in Table 1.

TABLE 1

| | | standard | |
|---|---|---|---|
| | | deviation | Average − |
| | Average | (σ) | 3σ |
| Entire Sample 1 (30 sheets) | 140.48 | 3.6 | 129.68 |
| Sample 1 divided into 10 | 140.48 | 5.38 | 124.35 |
| parts in longitudinal | | | |
| direction (30 sheets × 10) | | | |
| Entire Sample 2 (30 sheets) | 133.08 | 3.99 | 121.11 |
| Sample 2 both left and | 133.08 | 4.47 | 118.99 |
| right sides (30 sheets × 2) | | | |
| Sample 2 center portion | 132.39 | 4.47 | 119.68 |
| (30 sheets × 1) | | | |

Unit: kg/m3

In Table 1, all units are kg/m³.

Entire Sample 1 (30 sheets) shows the variation of the entire sample (population 30) regarding the 30 sheets of sample 1.

Sample 1 divided into 10 parts in the longitudinal direction (30 sheets×10) shows their variation (population 300) of the entire Sample 1 divided into 10 parts in the longitudinal direction at equal intervals. Entire Sample 2 (30 sheets) shows the overall variation regarding the 30 sheets of sample 2.

Both left and right sides of sample 2 (30 sheets×2) show the variation of both left and right sides (population 60) of the entire Sample 2 divided into 3 parts in the width direction at equal intervals.

Center portion of sample 2 (30 sheets×1) shows the variation of the center portion (population 30) by dividing all the Sample 1 into 10 parts at equal intervals in the longitudinal direction.

Consideration

As a result, it was confirmed that there was no significant difference in the amount of injected chemical agent in the longitudinal direction and the center portion, and both side portions and its variation. Therefore, it was confirmed that the chemical agent is injected uniformly throughout the panel board of Example.

In detail, the average −3σ is a numerical value that 99.7% or more of the samples are equal to or higher than this numerical value, and in general, it is the minimum guaranteed value in practice. Therefore, as an evaluation of Sample 1, it was confirmed that 99.7% was within the range of ±about 11% in the whole and the longitudinal direction of the veneer. In addition, as an evaluation of Sample 2, it was confirmed that there was no significant difference in the average value, standard deviation and minimum guaranteed value in the whole and in the width direction of the veneer.

Therefore, in the panel board of the present invention, it was confirmed by the Examples that it was possible to set the amount of chemical agent injected arbitrarily by adjusting the concentration of the injected chemical agent according to the tree species and the thickness of the veneer, and the same performance is guaranteed even when any portion of the thickness, length and width directions is taken. Therefore, for example, even if a business model is implemented in which a dry, ready-made product with a size of a thickness of 12 mm to 30 mm, a width of 310 mm and a length of 4,100 mm is produced and stored in stock, and then cut into the ordered size and delivered when receiving an order from the customer, it was confirmed that the chemical agent is uniformly injected into the entire panel board that has been delivered, and it is possible to guarantee the same performance.

### EXPLANATION OF REFERENCE NUMERALS

11 Panel board
12 Front and back surface
13 Left and right side
14 Front and rear end surface
21 Front and back veneer
31 Core veneer layer
32 Core veneer
A Sapwood section
B White line zone
C Heartwood matured section
D Heartwood unmatured section
S Veneer fiber direction of front and back veneer
T Veneer fiber direction of core veneer

1. A semi-incombustible panel board that is a panel board in which a plurality of veneers is laminated, comprising:
front and back veneers constituting a front and back of the panel board; and
a core veneer layer laminated between the front and back veneers,
wherein a veneer fiber direction of the front and back veneers is substantially parallel to a lengthwise direction of the panel board,
wherein the core veneer layer is a layer in which a plurality of sheets of core veneers are stacked in a thickness direction,
wherein veneer fiber directions of all of the core veneers are substantially orthogonal to the lengthwise direction of the panel board,
wherein the front and back veneers have a thickness of 1.5 mm to 4.0 mm,
wherein a thickness of the core veneer layer is equal to or greater than a total thickness of the front and back veneers,
wherein in the front and back surface veneers, a fireproofing agent that has infiltrated from a cross-grain surface through lathe checks of the veneer or fine cracks generated during veneer processing with an aqueous solution exists throughout the front and back surface veneers, and
in the core veneers, a fireproofing treatment agent that has moved fluidly along the veneer fiber direction in lathe checks of the veneer generated along a vessel or tracheid exists throughout the core veneers.

2. The semi-incombustible panel board according to claim 1, wherein the core veneer layer is a rotary veneer, and
wherein the whole panel board has a thickness of 12 mm to 30 mm, a width of 100 mm to 310 mm and a length of 2,000 mm to 4,500 mm.

3. A method for producing the semi-incombustible panel board according to claim 1, comprising the steps of:
preparing a panel board raw material for stock having the same laminated structure and thickness as the semi-incombustible panel board, and having at least one of a width dimension and a length dimension larger than the semi-incombustible panel board, and injecting a fireproofing treatment agent into the panel board raw material for stock to produce a semi-incombustible panel board for stock; and
cutting at least any one of the width dimension and the length dimension of the semi-incombustible panel board for stock to produce the semi-incombustible panel board.

4. The method for producing the semi-incombustible panel board according to claim 3,
wherein the semi-incombustible panel board for stock has a thickness of 30 mm or less and a width of 310 mm or less, and
wherein a thickness of the front and back veneers constituting the front and back of the semi-incombustible panel board for stock is 1.5 mm to 4.0 mm.

5. A method for producing the semi-incombustible panel board according to claim 2, comprising the steps of:
preparing a panel board raw material for stock having the same laminated structure and thickness as the semi-incombustible panel board, and having at least one of a width dimension and a length dimension larger than the semi-incombustible panel board, and injecting a fireproofing treatment agent into the panel board raw material for stock to produce a semi-incombustible panel board for stock; and
cutting at least any one of the width dimension and the length dimension of the semi-incombustible panel board for stock to produce the semi-incombustible panel board.
